(19) United States
(12) Patent Application Publication
(10) Pub. No.: US 2014/0242909 A1
(43) Pub. Date: Aug. 28, 2014

(54) METHOD AND APPARATUS FOR MANAGING DATA IN NEAR FIELD COMMUNICATION SYSTEM

(71) Applicant: Samsung Electronics Co., Ltd., Gyeonggi-do (KR)

(72) Inventors: Doyoung Kim, Gyeonggi-do (KR); Dongkeon Kong, Gyeonggi-do (KR); Dongwoo Kim, Seoul (KR); Jeongje Park, Gyeonggi-do (KR); Kwanghyeon Lee, Seoul (KR); Naehyun Lim, Seoul (KR); Hyoungkyu Lim, Seoul (KR); Yong Chang, Gyeonggi-do (KR)

(73) Assignee: Samsung Electronics Co., Ltd., Gyeonggi-do (KR)

(21) Appl. No.: 14/187,808

(22) Filed: Feb. 24, 2014

(30) Foreign Application Priority Data
Feb. 22, 2013 (KR) 10-2013-0019428

(51) Int. Cl. H04B 5/00

(52) U.S. Cl. CPC H04B 5/0031
USPC 455/41.1

(57) ABSTRACT

A data managing method of a terminal in a Near Field Communication (NFC) system. The data managing method includes setting up an NFC link with a server; transmitting to the server, a request message including access level information of the terminal; and receiving from the server, a response message that classifies whether data access is allowed or restricted, based on an access level of the terminal, wherein the access level information of the terminal is included in a header of the request message.

### PRIORITY

This application claims priority under 35 U.S.C. §119(a) to Korean Patent Application Serial No. 10-2013-0019428, which was filed in the Korean Intellectual Property Office on Feb. 22, 2013, the entire content of which is incorporated herein by reference.

### BACKGROUND OF THE INVENTION

1. Field of the Invention

The present invention relates generally to a method and apparatus of managing data in a near field communication system, and more particularly, to a method that classifies a medical data access level of a terminal using a field included in a data exchange protocol header, and an apparatus supporting the same.

2. Description of the Related Art

Recently, a technology that manages medical data using Near Field Communication (NFC) has been commonly used. For example, a patient generates medical data using a body composition measuring device, a glucometer, a blood pressure meter, and the like, and immediately transmits the generated medical data through an NFC module. Subsequently, a physician may receive and read the medical data by accessing a server through an NFC module included in a terminal of the physician, and generates and transmits checkup data. Users may transmit generated medical data to other terminals based on a peer-to-peer scheme.

However, the peer-to-peer scheme does not assign each terminal with an access level associated with each data and thus, all of the medical data may be accessed without distinction of data when an NFC connectivity between a terminal and a server is established.

For example, allowable ranges of reading medical data of patients managed in a hospital for a medical team such as physicians or nurses and for a non-medical team such as clerks at a reception desk may be distinguished. In addition, access to medical data of a patient is restricted to one's own data, and medical data of another patient is inaccessible.

FIG. 1 is a diagram illustrating a problem when medical data is shared using a network inside and outside a hospital.

As illustrated in FIG. 1, when medical data is transmitted over an Internet network, there may be a drawback in that illegal access or falsification may occur. As medical data has been frequently exchanged between hospitals or between a hospital and an insurance company, a need for data management has been increased.

### SUMMARY OF THE INVENTION

The present invention has been made to solve at least the above-described problems, and to provide at least the advantages described below.

Accordingly, an aspect of the present invention is to provide a method of managing data that assigns a terminal with an access level for medical data so as to secure personal information, and an apparatus supporting the same.

According to another aspect of the present invention, a data access level of a terminal may be assigned using a field included in a Near Field Communication (NFC) data exchange protocol header and thus, security and efficiency of managing medical data may be strengthened.

In accordance with an aspect of the present invention, a data managing method of a terminal is provided. The data managing method includes setting up a near field communication link with a server; transmitting, to the server, a request message including access level information of the terminal; and receiving, from the server, a response message that classifies whether data access is allowed or restricted, based on an access level of the terminal, wherein the access level information of the terminal is included in a header of the request message.

In accordance with another aspect of the present invention, a data managing method of a server is provided. The data managing method includes setting up a near field communication link with a terminal; receiving, from the terminal, a request message including access level information of the terminal; and transmitting, to the terminal, a response message that classifies whether data access is allowed or restricted, based on an access level of the terminal, wherein the access level information of the terminal is included in a header of the request message.

In accordance with another aspect of the present invention, a terminal for managing data is provided. The terminal includes a wireless communication unit that transmits and receives a signal to/from a server; and a controller that performs controlling to set up a near field communication link with the server, to transmit, to the server, a request message including access level information of the terminal, and to receive, from the server, a response message that classifies whether data access is allowed or restricted based on an access level of the terminal, wherein the access level information of the terminal is included in a header of the request message.

In accordance with another aspect of the present invention, a server that manages data is provided. The server includes a wireless communication unit that transmits and receives a signal to/from a terminal; and a controller that performs controlling to set up a near field communication link with the terminal, to receive, from the terminal, a request message including access level information of the terminal, and to transmit, to the terminal, a response message that classifies whether data access is allowed or restricted based on an access level of the terminal, wherein the access level information of the terminal is included in a header of the request message.

### BRIEF DESCRIPTION OF THE DRAWINGS

The above and other aspects, features and advantages of the present invention will be more apparent from the following detailed description, taken in conjunction with the accompanying drawings, in which:

FIG. 1 is a diagram illustrating a problem when medical data is shared using a network inside and outside a hospital;

FIG. 2 is a diagram illustrating a part that is a threat to security when access to medical data occurs using a smart phone;

FIG. 3 is a diagram illustrating a configuration of a terminal according to an embodiment of the present invention;

FIG. 4 is a diagram illustrating utilization of the present invention;

FIG. 5 is a flowchart illustrating a data managing method according to an embodiment of the present invention;

FIG. 6 is a signal flow diagram illustrating a data managing method according to an embodiment of the present invention;

FIG. 7 is a diagram illustrating a message format in a data managing method according to an embodiment of the present invention;

FIG. 8A is a flowchart illustrating a process that assigns an identification (ID) or an access level of a patient's terminal, and manages medical data;

FIG. 8B is a flowchart illustrating a process that assigns an ID or an access level of a medical team's terminal, and manages medical data;

FIGS. 9A through 9C are signal flow diagrams illustrating a data managing method according to embodiments of the present invention;

FIG. 10 is a diagram illustrating a message format in a data managing method according to an embodiment of the present invention; and

FIG. 11 is a signal flow diagram illustrating a data managing method according to an embodiment of the present invention.

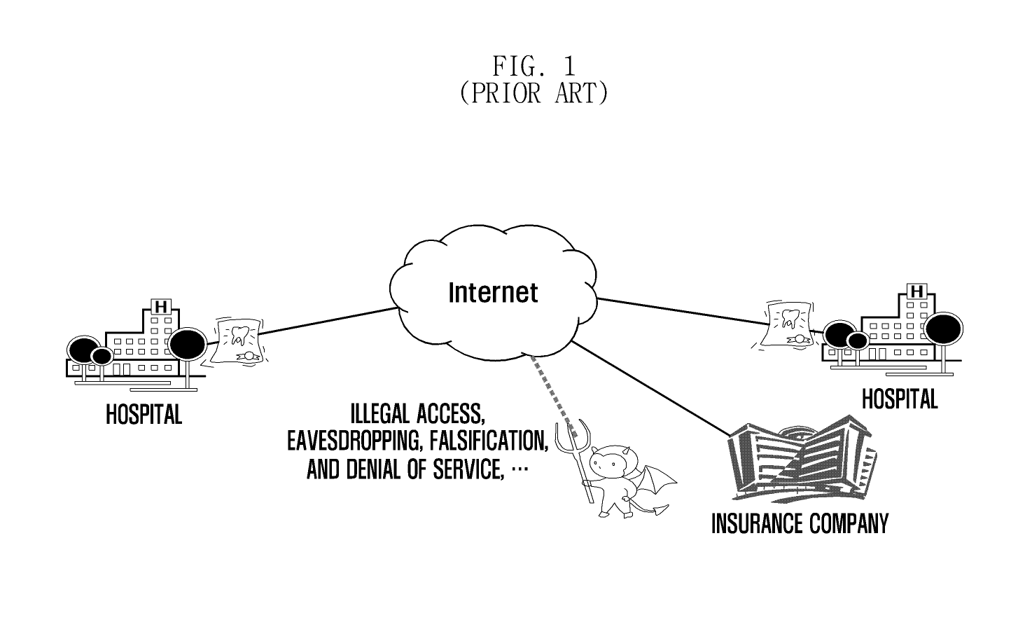

### DETAILED DESCRIPTION OF EMBODIMENTS OF THE PRESENT INVENTION

Hereinafter, various embodiments of the present invention will be described with reference to the accompanying drawings. Further, in the following description of the present invention, a detailed description of known functions and configurations incorporated herein will be omitted when it may obscure the subject matter of the present invention in unnecessary detail.

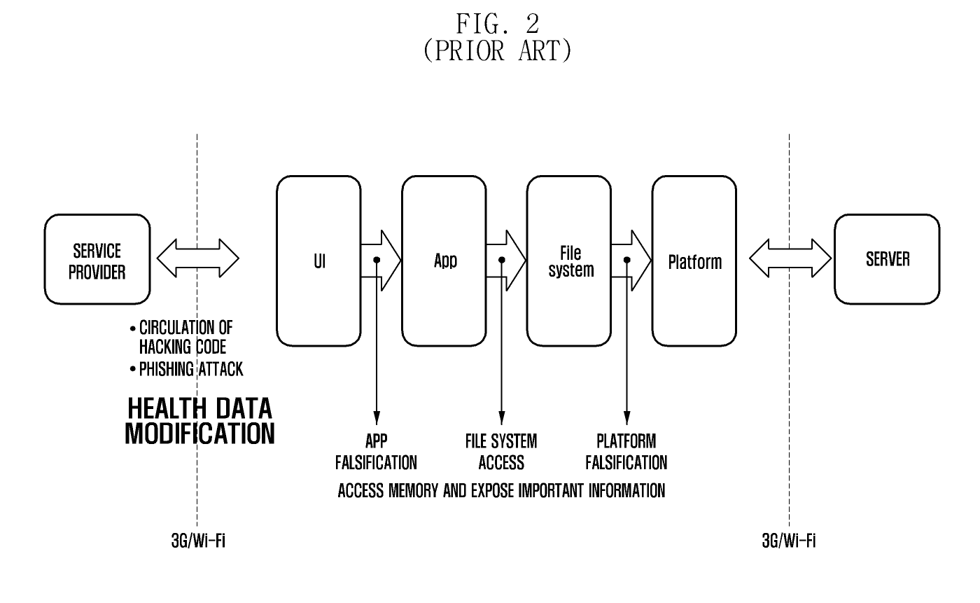

FIG. 2 is a diagram illustrating a part that is a threat to security when access to medical data occurs using a smart phone.

When medical data is managed using a smart phone according to the conventional art, generally a health care device manufacturing firm generates an NFC health library, and a content provider includes the NFC health library in an application (app). A terminal supports an NFC Application Programming Interface (API) so as to receive a device measurement signal.

However, there is a drawback in that a function of distinguishing user data and transmitted/received data does not exist between a terminal and a server.

In this case, as illustrated in FIG. 2, problems such as circulation of hacking codes, phishing attacks, application falsification, platform falsification, and the like may occur. When NFC is applied according to the conventional art, a security service for data exchanging and a protocol are based on the Near Field Communication-SECurity (NFC-SEC) standard.

However, in the standard, only an NFC interface exists and a standard for distinction of multiple users does not exist. That is, a medical team, a non-medical team, or a patient may use an identical interface without distinction. As such, the standard does not include a method of preventing access to medical data which should not be made available to the non-medical team.

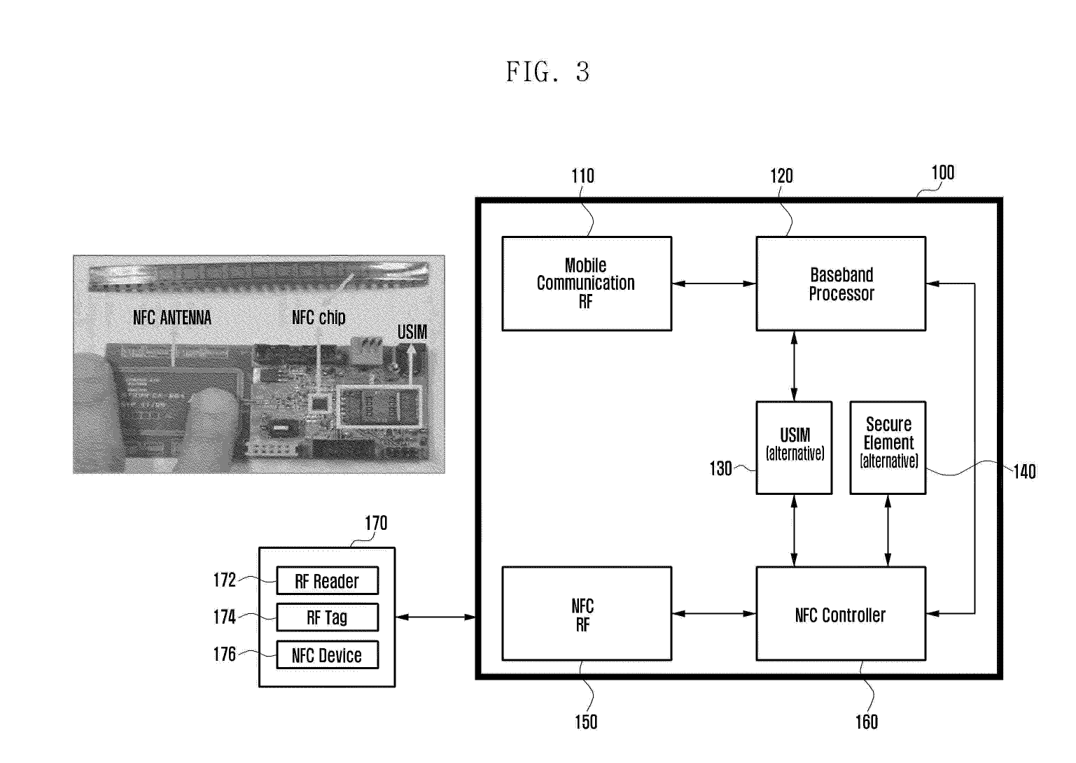

FIG. 3 is a diagram illustrating a configuration of a terminal according to an embodiment of the present invention. As illustrated in FIG. 3, a portable terminal 100 according to an embodiment of the present invention includes a mobile communication Radio Frequency (RF) unit 110, a baseband processor 120, an NFC controller 160, and an NFC RF unit 150. In addition, a portable terminal according to an embodiment of the present invention may selectively (as an alternative) include a Universal Subscriber Identity Module (USIM) 130 or a secure element 140.

In FIG. 3, the mobile communication RF unit 110 and the NFC RF unit 150, and the baseband processor 120 and the NFC controller 160 have been distinctively displayed, the portable terminal 100 of the present invention is not limited thereto. That is, a wireless communication unit of the terminal according to an embodiment of the present invention may include only an NFC RF unit 150, and may also execute a role of an NFC controller 160 in a single processor that is physically not separated.

Here, the portable terminal according to an embodiment of the present invention may include a portable phone, a smart phone, a digital broadcasting receiver, a Personal Digital Assistant (PDA), an International Mobile Telecommunication 2000 (IMT-2000) terminal, a Wideband Code Division Multiple Access (WCDMA) terminal, and a Universal Mobile Telecommunication Service (UMTS) terminal, and the like, as a personal communication terminal equipped with a wireless communication function.

The mobile communication RF unit 110 executes a function of transmitting and receiving corresponding data for wireless communication of a portable terminal. The mobile communication RF may be configured to include an RF transmitter that up-converts and amplifies a frequency of a transmitted signal, an RF receiver that low-noise amplifies and down-converts a received signal, and the like. Also, the mobile communication RF receives data through a radio channel and outputs the received data to the baseband processor, and transmits data output from the baseband processor through the radio channel.

The NFC RF unit 150 executes a function of transmitting and receiving corresponding data for Near Field Communication of the portable terminal 100. The NFC RF unit 150 may connect Near Field Communication with another NFC device of a Peer-to-Peer scheme or with an RF Tag or an RF Reader of a Proximity Card scheme. That is, the NFC RF unit 150 according to an embodiment of the present invention may support all of a Peer-to-Peer connectivity, a contactless smart card (ISO 14443, Proximity IC Card), and a contact smart card (ISO 7816).

Although not specified in FIG. 3, portable terminal 100 according to an embodiment of the present invention may further include an input unit, a touch screen unit, and a storage unit.

The input unit receives a user input for controlling a portable terminal, and generates an input signal and transfers the input signal to the baseband processor 120. The input unit may be configured to include a keypad including number keys and direction keys, and may be formed as predetermined function keys in one side of a portable terminal.

The touch screen unit includes a touch panel and a display unit. The touch panel senses a touch input of a user. The touch panel may be formed of a touch sensor such as a capacitive overlay touch sensor, a resistive overlay touch sensor, an infrared beam sensing touch sensor, and the like, or may be formed of a pressure sensor. In addition to the sensors, all types of sensing devices that may sense a contact or a pressure of an object may be used for forming a touch panel.

The touch panel senses a touch input of a user, generates a sensing signal, and transmits the generated sensing signal to the baseband processor 120. The sensing signal includes coordinate data associated with coordinates on which the user inputs a touch. When the user inputs a motion of moving a position of a touch, the touch panel generates a sensing signal including coordinate data associated with a path through which the position of the touch is moved, and transmits the sensing signal to the baseband processor 120.

The display unit may be formed of a Liquid Crystal Display (LCD), an Organic Light Emitting Diode (OLED) display, an Active Matrix Organic Light Emitting Diode (AMOLED) display, and the like, and may visually provide a menu of a portable terminal, input data, function setting information, and other various information.

The storage unit may execute a function of storing programs and data required for operations of a portable terminal, and may be divided into a program area and a data area.

The program area may store programs for controlling general operations of a portable terminal, and programs provided as default such as an operating system (OS) that boots up a portable terminal and the like.

The program area of the storage unit may store an application that is separately installed by a user, for example, a blood sugar managing application, a menstrual period application, and the like. The data area may be an area that stores data generated as a portable terminal is utilized, and may store an image, a video, a phone book, audio data, and the like. In particular, the data area according to an embodiment of the present invention stores medical data information.

The input unit receives a user input for controlling a portable terminal, generates an input signal, and transfers the input signal to the baseband processor 120. The input unit may be configured to include a keypad including number keys and direction keys, and may be formed as predetermined function keys in one side of a portable terminal. In a preferable embodiment of the present invention, a portable terminal may be manipulated using only the touch screen unit. In this case, the touch panel may execute a function of the input unit.

The baseband processor 120 controls general operations of each component element of a portable terminal. The NFC controller 160 controls general operations associated with NFC.

In particular, in a portable terminal according to an embodiment of the present invention, the NFC processor 160 controls a series of processes of setting up a near field communication link with a medical data management server, transmitting, to the server, a request message including access level information of a terminal, and receiving, from the server, a response message that classifies whether data access is allowed or restricted based on an access level of the terminal.

The NFC processor 160 performs a control operation to transmit, to the medical data management server, a message that requests issuing of at least one of an IDentification (ID) and an access level, and receiving, from the server, a response message that assigns at least one of the ID and the access level. A method of implementing the above will be described with reference to the attached drawings.

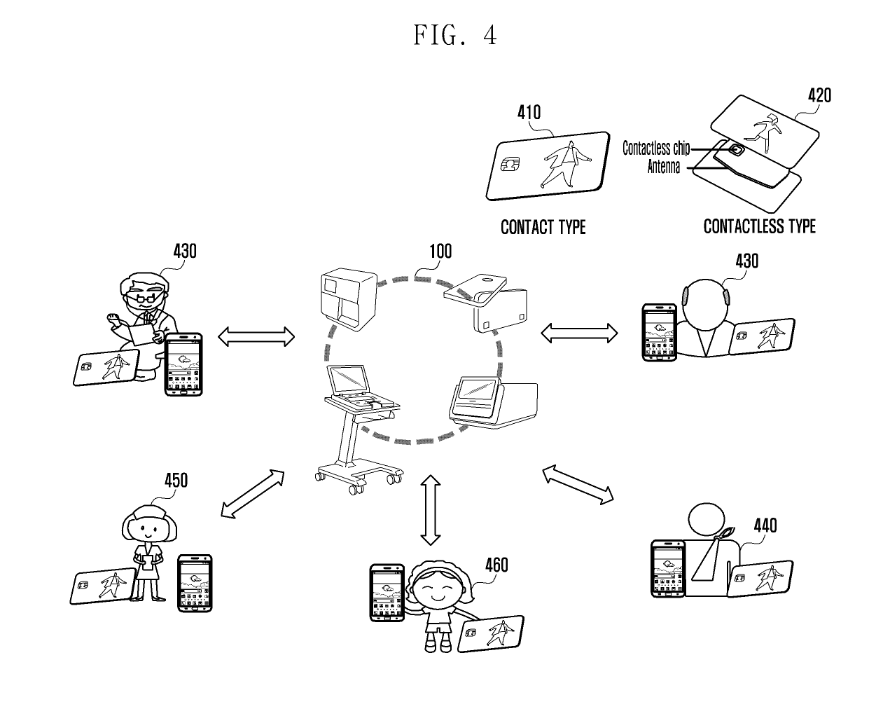

FIG. 4 is a diagram illustrating utilization of the present invention. As illustrated in FIG. 4, a terminal 100 according to an embodiment of the present invention may support a contact 410 or contactless 420 near field communication, and transmits and receives medical data by connecting near field communication to various medical devices used by physicians 430, patients 440 nurses 450, and guardians or families 460 of patients.

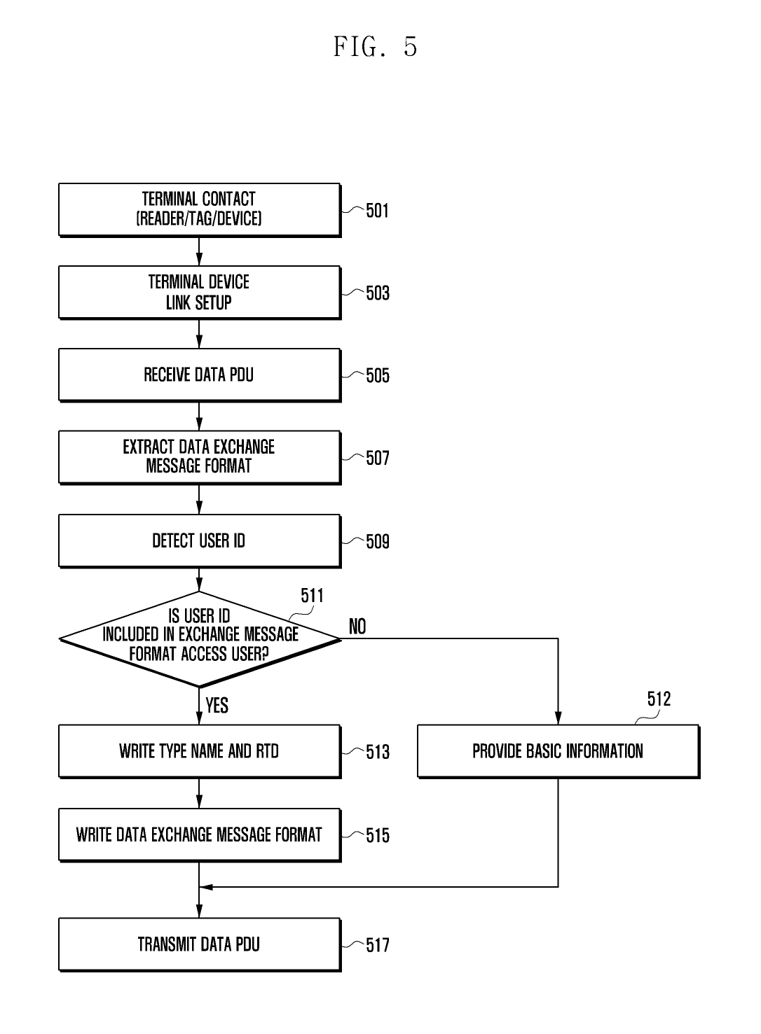

FIG. 5 is a flowchart illustrating a data managing method according to an embodiment of the present invention.

As illustrated in FIG. 5, in steps 501 and 503, a terminal sets up a near field communication link with another NFC electronic device 170, such as a reader 172, a tag 174, another NFC device 176, and the like, through a contact or contactless scheme.

Subsequently, in step 505, the NFC electronic device receives a data Protocol Data Unit (PDU) from a terminal to which the near field communication is connected. The NFC electronic device extracts a data exchange message format from the PDU in step 507, so as to detect a user ID of the terminal in step 509.

It is then determined if the user ID is included in the exchange message format access user in step 511, and if so, the electronic device writes a type name and a Record Type Definition (RTD) in step 513, writes a data exchange message format in step 515, and transmits the data PDU in step 517 using the same. Conversely, when the user ID is not included in the exchange message format access user in step 511, the electronic device transmits the data PDU by providing only basic information in step 512.

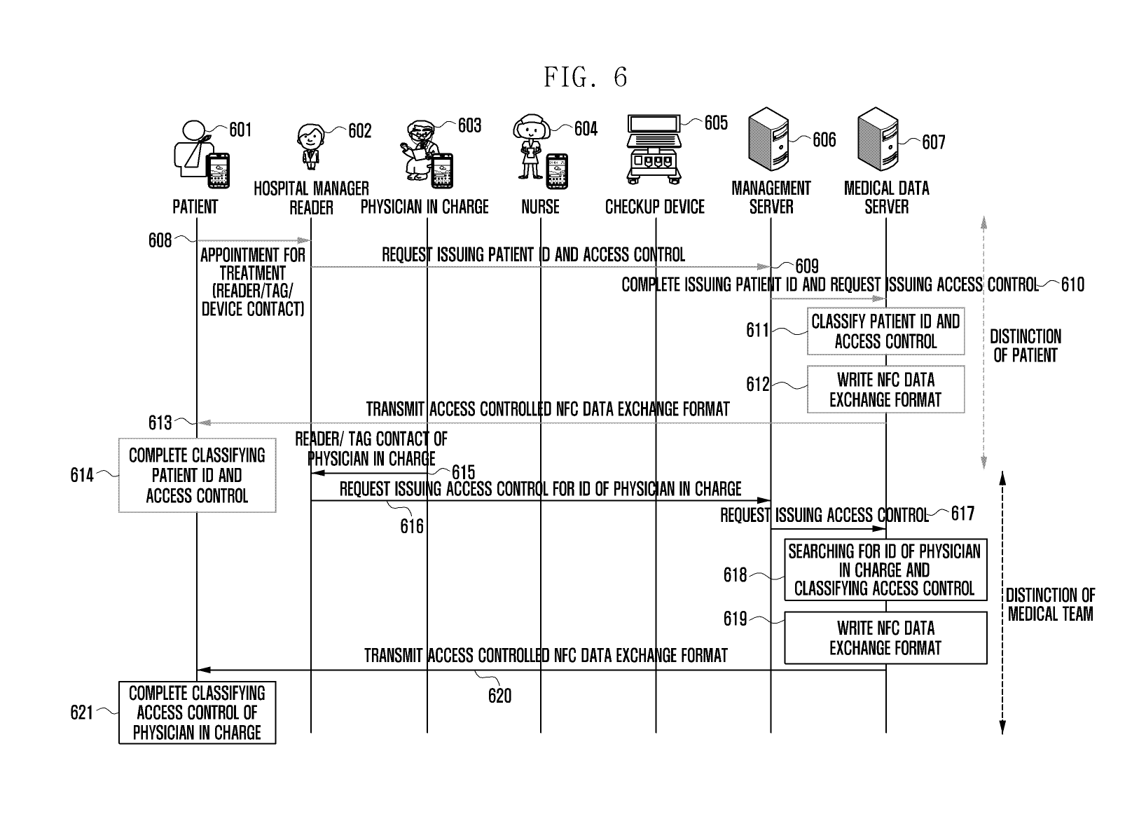

FIG. 6 is a diagram illustrating a method for various terminals and electronic devices to manage medical data according to an embodiment of the present invention.

A patient 601 may access a reader of a hospital manager 602 for arranging an appointment for medical treatment in step 608 using a terminal according to an embodiment of the present invention. The reader of the hospital manager 602 transmits, to a management server 606, a request message for requesting issuing of a patient ID and an access control in step 609. The management server 606 accesses a medical data server 607 so as to transfer the request message for requesting issuing of the patient ID and the access control in step 610.

Subsequently, the medical data server 607 writes an NFC Data Exchange Format (DEF) in step 612 by classifying a patient ID and an access control in step 611 on distinction of a patient (as classified with patient). Also, the medical data server 607 transmits, to a patient's terminal 601, an access controlled NFC DEF in step 613.

A physician 603 may access a reader of a hospital manager 602 using a terminal according to an embodiment of the present invention in step 615. The reader of the hospital manager 602 transmits, to a management server 606, a request message for requesting issuing of a physician ID and an access control in step 616. The management server 606 accesses a medical data server 607 so as to transfer the request message for requesting issuing of the patient ID and the access control in step 617.

Subsequently, the medical data server 608 writes an NFC DEF in step 619 by classifying a physician ID and an access control based on distinction of a medical team in step 618. Also, the medical data server 607 may transmit, to a physician's terminal, an access controlled NFC DEF in step 620.

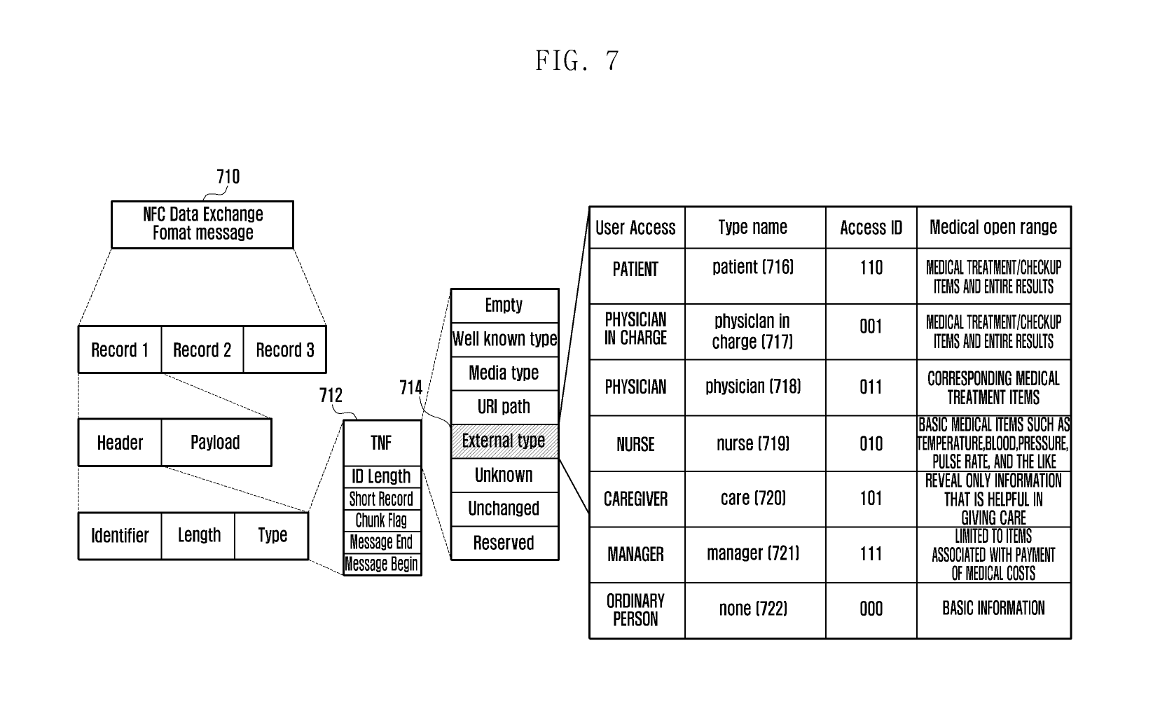

FIG. 7 is a diagram illustrating a message format in a data managing method according to an embodiment of the present invention.

According to an embodiment of the present invention, access level information of a terminal may be classified in an NFC DEF message format 710 using a Type Name Format (TNF) field 712. That is, the access level information may be set using a header of an NFC DEF message 710, and particularly, a TNF field 712, and more particularly, three bits of an External type field 714 in the TNF field 712. Here, the DEF indicates Data Exchange Format in the NFC standard.

FIG. 7 illustrates a case in which users are classified into seven types, and the type names are distinguished as “patient” 716, “physician_in_charge” 717, “physician” 718, “nurse” 719, “care” 720, “manager” 721, and “none” 722, and their External types or Access IDs are distinguished as 110, 001, 011, 010, 101, 111, and 000, respectively.

For a configuration of a type prefix and a domain according to an embodiment of the present invention, urn (uniform resource name), nfc (namespace identifier), ext (namespace specific string), and a domain type may be used. For example, a classification message of a patient 716 may be defined to be urn:nfc:ext:patient:f, a classification message of a physician-in-charge 717 may be defined to be urn:nfc:ext:physician_in_charge:f, and a classification message of a nurse 719 may be defined to be urn:nfc:ext:nurse:f.

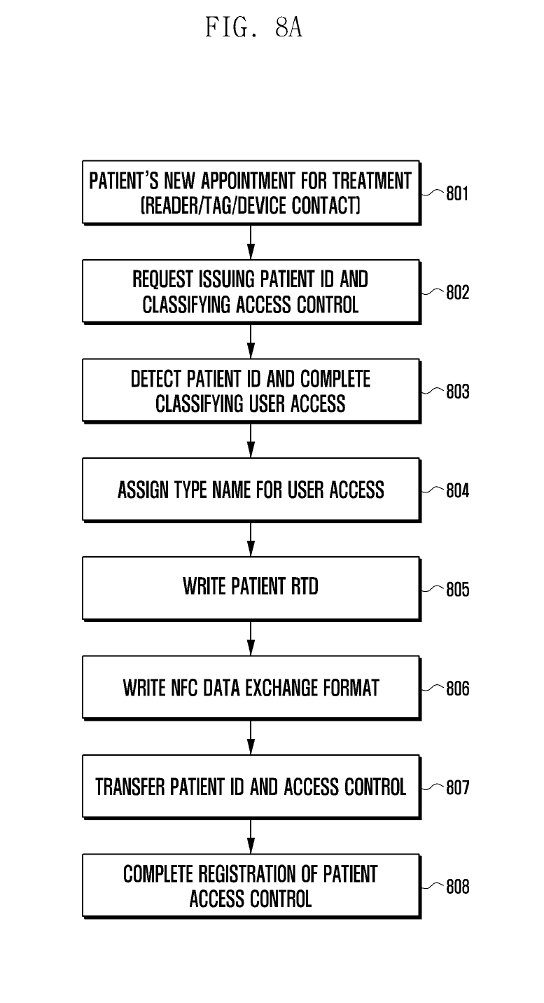

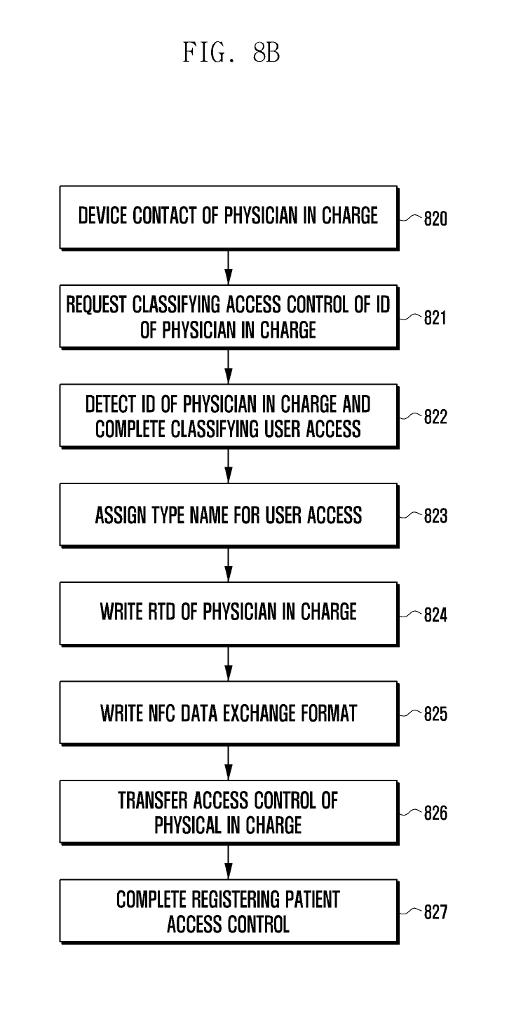

FIG. 8A and FIG. 8B are diagrams illustrating a method of managing medical data according to an embodiment of the present invention. In particular, FIG. 8A illustrates a method for a patient to manage medical data using a terminal according to an embodiment of the present invention, and FIG. 8B illustrates a method for a physician to manage medical data using a terminal according to an embodiment of the present invention.

When a user accesses a reader of a hospital manager using near field communication for scheduling an appointment in step 801 (and step 820), a medical data server may request and detect a patient ID or a physician ID based on whether the access corresponds to a patient of a physician in steps 802 and 803 (and steps 821 and 822), so as to assign a Type name corresponding to the user access in step 804 (and step 823).

Subsequently, the medical data server writes an RTD based on the Type name in step 805 (and step 824), and writes an NFC data exchange format in step 806 (and step 825), so as to issue an ID of a patient or a physician in charge and to register an access control to the server in step 807 (and step 826). The registration process is completed in step 808 (and step 827).

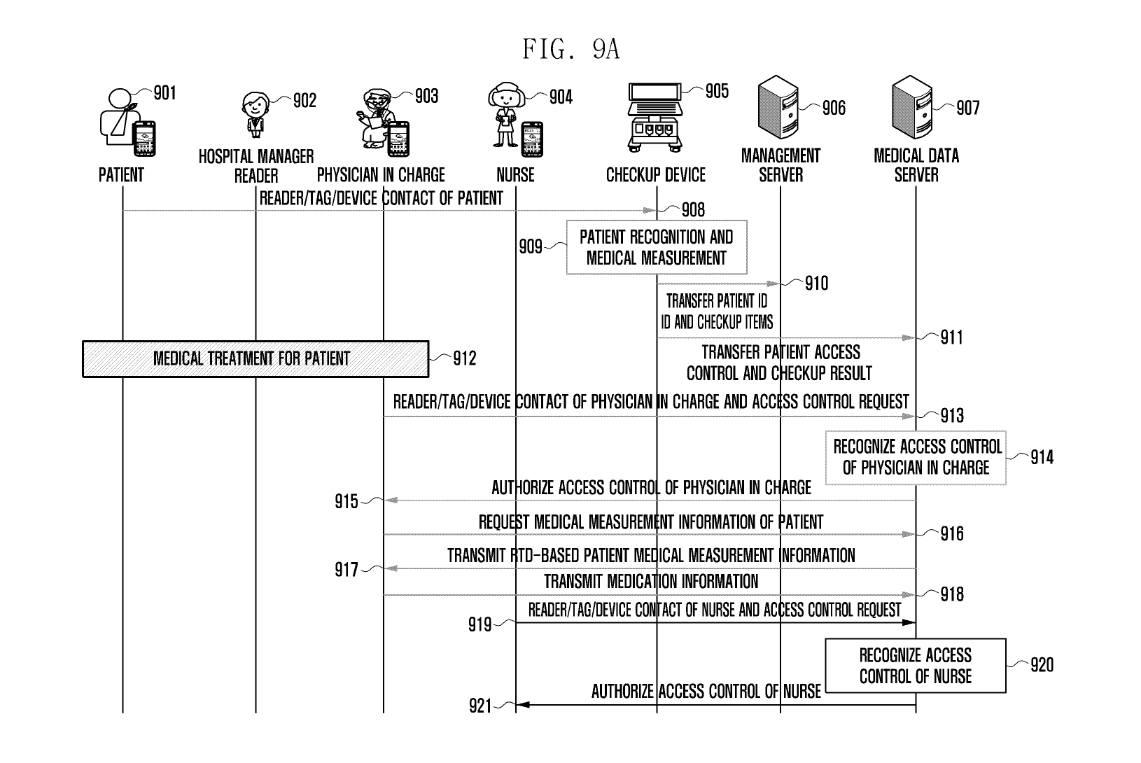

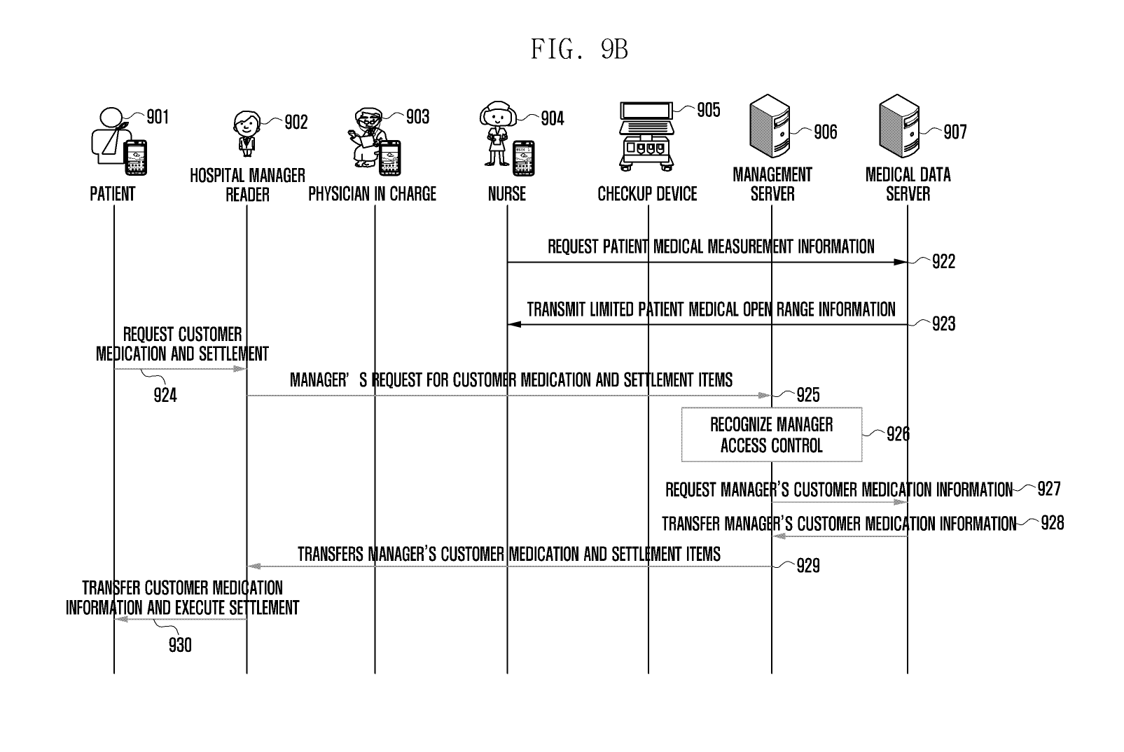

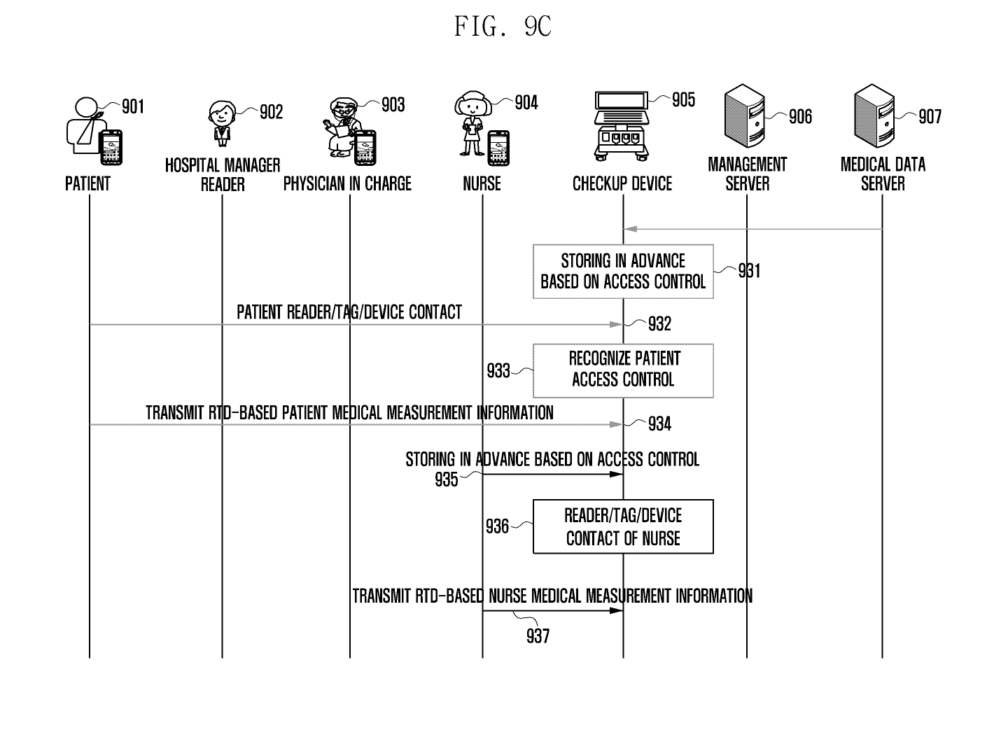

FIGS. 9A, 9B, and 9C are diagrams illustrating a method of managing medical data according to an embodiment of the present invention.

In particular, FIG. 9A illustrates a case in which a patient accesses a checkup device using a terminal according to an embodiment of the present invention, generates medical data, and uses the generated medical data for medical treatment.

As illustrated in FIG. 9A, the patient 901 accesses the checkup device in step 908 using the terminal according to an embodiment of the present invention, executes a checkup using the checkup device 905, and generates the medical data in step 909. The generated medical data 909 may be transmitted to a management server 906 in step 910 and to a medical data server 907 in step 911 together with an ID of the patient through the checkup device 905, and may be stored in the medical data server 907.

Subsequently, when a physician in charge 903 gives medical treatment 912 to the patient, the physician 903 accesses the medical data server 907 in step 913 using a terminal according to an embodiment of the present invention, the medical data server recognizes the physician in charge in step 914, authorizes an access control of the physician in charge in step 915, determines that access to the medical data of the patient is allowed for an ID of the physician, receives a request for patient information in step 916 and transmits the medical data to the terminal of the physician in step 917.

Subsequently, when the physician in charge 903 transmits medication information to the medical data server 907 in step 918, a nurse 904 accesses the medical data server 907 using a terminal according to an embodiment of the present invention in step 919, the medical data server 907 authorizes an access control of the nurse in step 920, determines that access to the medication information of the patient is allowed for an ID of the nurse, and transmits the medical data to the terminal of the nurse in step 921.

FIG. 9B illustrates a case in which a nurse accesses a medical data server using a terminal according to an embodiment of the present invention, receives medical measurement information of a patient, and uses the medical measurement information for medication and settlement.

As illustrated in FIG. 9B, the nurse 904 may request medical measurement information of a patient in step 922 from the medical data server 907 using a terminal according to an embodiment of the present invention. The medical data server 907 may transmit limited medical data in step 923 such as medication information and the like, based on an access level of the nurse 904.

When a patient 901 accesses a reader of a hospital manager 902 using a terminal according to an embodiment of the present invention in step 924 so as to request medication information and payment, the reader of the hospital manager 902 sends a request in step 925 to the management server 906, which recognizes the reader of the hospital manager 902 in step 926. The management server 906 sends a request to the medical data server 907 in step 927, which transfers medication information back to the management server 906 in step 928. The management server 906 then transfers medication information and payment items from the medical data server 907 to the hospital manager reader 902 in step 929, which forwards the information to the patient 901 in step 930.

FIG. 9C illustrates a case in which a checkup device according to an embodiment of the present invention is used for medical work.

As illustrated in FIG. 9C, a medical data server 907 may store in step 931 medical data in the checkup device 905 before being requested by a patient in step 932, a physician 903, or the like. The medical data may be managed based on an access control so as to assign an access level in advance for each terminal in step 933.

Subsequently, when a patient 901, a nurse 904, or the like accesses a checkup device 905 using a terminal according to an embodiment of the present invention, the medical device may transmit medical data, or may restrict the access, based on the access control in steps 934 to 937.

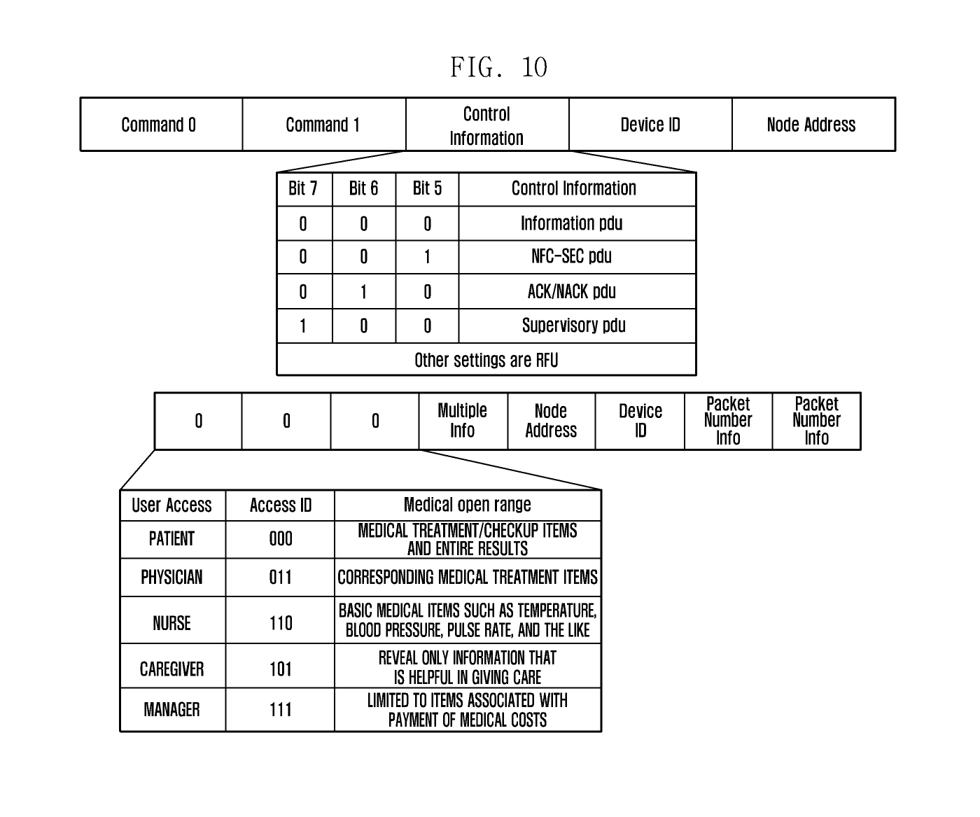

FIG. 10 is a diagram illustrating a message format in a data managing method according to an embodiment of the present invention.

According to an embodiment of the present invention, access level information of a terminal may be classified based on a field included in an information PDU. That is, the access level information may be set using three empty bits as an information PDU of control information.

FIG. 10 illustrates a case in which 5 user distinctions are used and their information PDUs are distinguished as 000, 011, 110, 101, and 111, respectively. For example, according to an embodiment of the present invention, when the information PDU is 000, access to entire data associated with medical treatment/checkup items and their results is set to be allowed, when the information PDU is 011, only access to corresponding medical treatment items is set to be allowed, when the information PDU is 110, only access to a basic medical treatment items such as a body temperature, a blood pressure, a pulse rate, and the like is set to be allowed, when the information PDU is 101, only access helpful to a caregiver is set to be allowed, and when the information PDU is 111, only access to an item for payment of medical costs is set to be allowed.

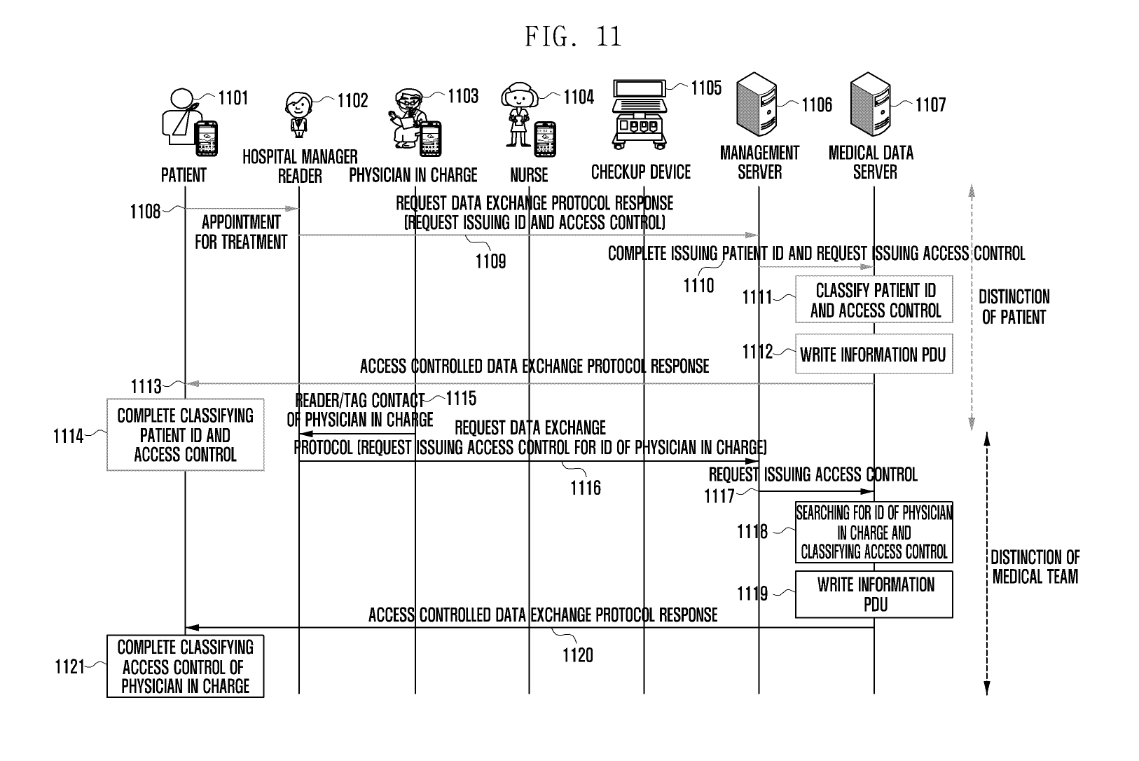

FIG. 11 is a diagram illustrating a method for various terminals and electronic devices to manage medical data according to an embodiment of the present invention.

A patient 1101 may access a reader of a hospital manager 1102 for arranging a medical treatment in step 1108 using a terminal according to an embodiment of the present invention. The reader of the hospital manager 1102 transmits in step 1109, to a management server 1106, a request message for requesting issuing of a patient ID and an access control. The management server 1106 accesses a medical data server 1107 in step 1110 so as to transfer the request message for requesting issuing of the patient ID and the access control.

Subsequently, the medical data server 1107 classifies the patient ID and the access control based on distinction of a patient in step 1111, writes the information PDU in step 1112, and transmits the access controlled data exchange protocol to a patient's terminal in step 1113 and step 1114.

A physician in charge 1103 may access in step 1115 the reader of a hospital manager 1102 using a terminal according to an embodiment of the present invention. The reader of the hospital manager 1102 transmits, to the management server 1106, a request message for requesting issuing of a physician ID and an access control in step 1116. The management server 1106 accesses the medical data server 1107 so as to transfer the request message in step 1117 for requesting issuing of the patient ID and the access control.

Subsequently, the medical data server 1107 classifies the physician ID and the access control based on distinction of a medical team, writes the information PDU in step 1119, and transmits the access controlled data exchange protocol to a physician's terminal in steps 1120 and 1121.

Those skilled in the art can appreciate that it is possible to implement the present invention in another specific form without changing the technical idea or the indispensable characteristics of the present invention. Therefore, it should be understood that the above-described embodiments are illustrative and are not limiting under any possible interpretation. The scope of the present disclosure is defined by the appended claims to be described later, rather than the detailed description. Accordingly, it should be appreciated that all modifications or variations derived from the meaning and scope of the appended claims and their equivalents are included in the range of the present invention.

Although certain embodiments of the present invention have been shown and described in this specification and the drawings, they are used in a general sense in order to easily explain the technical contents of the present invention, and to help comprehension of the present invention, and are not intended to limit the scope of the present invention. It is obvious to those skilled in the art to which the present invention pertains that other modified embodiments on the basis of the spirit of the present invention besides the embodiments disclosed herein can be carried out.

What is claimed is:

1. A method of managing data of a terminal in a Near Field Communication (NFC) system, the method comprising:
setting up an NFC link with a server;
transmitting, to the server, a request message including access level information of the terminal; and
receiving, from the server, a response message that classifies whether data access is allowed or restricted, based on an access level of the terminal,
wherein the access level information of the terminal is included in a header of the request message.

2. The method of claim 1, wherein, before transmitting the request message, the method further comprises:
transmitting, to the server, a message for requesting issuing of at least one of an IDentification (ID) and the access level; and
receiving, from the server, a response message that assigns at least one of the ID and the access level.

3. The method of claim 2, wherein the access level information is included in a Type Name Format (TNF) field of the header.

4. The method of claim 3, wherein the access level information is included in an External type field of the TNF field.

5. A method of managing data of a server in a Near Field Communication (NFC) system, the method comprising:
setting up an NFC link with a terminal;
receiving, from the terminal, a request message including access level information of the terminal; and
transmitting, to the terminal, a response message that classifies whether data access is allowed or restricted, based on an access level of the terminal,
wherein the access level information of the terminal is included in a header of the request message.

6. The method of claim 5, wherein, before receiving the request message, the method further comprises:
receiving, from the terminal, a message that requests issuing at least one of an IDentification (ID) and the access level; and
transmitting, to the terminal, a response message that assigns at least one of the ID and the access level.

7. The method of claim 6, wherein the access level information is included in a Type Name Format (TNF) field of the header.

8. The method of claim 7, wherein the access level information is included in an External type field of the TNF field.

9. A terminal for managing data in a Near Field Communication (NFC) system, the terminal comprising:
a wireless communication unit that transmits and receives a signal to/from a server; and
a controller configured to perform controlling to set up an NFC link with the server to transmit, to the server, a request message including access level information of the terminal, and to receive from the server, a response message that classifies whether data access is allowed or restricted based on an access level of the terminal,
wherein the access level information of the terminal is included in a header of the request message.

10. The terminal of claim 9, wherein the controller is further configured to perform controlling to transmit to the server, a message that requests issuing at least one of an IDentification (ID) and the access level, and to receive from the server, a response message that assigns at least one of the ID and the access level.

11. The terminal of claim 10, wherein the access level information is included in a Type Name Format (TNF) field of the header.

12. The terminal of claim 11, wherein the access level information is included in an External type field of the TNF field.

13. A server that manages data in a Near Field Communication (NFC) system, the server comprising:
a wireless communication unit that transmits and receives a signal to/from a terminal; and
a controller configured to perform controlling to set up an NFC link with the terminal to receive, from the terminal, a request message including access level information of the terminal, and to transmit to the terminal, a response message that classifies whether data access is allowed or restricted based on an access level of the terminal,
wherein the access level information of the terminal is included in a header of the request message.

14. The server of claim 13, wherein the controller is further configured to perform controlling to receive from the terminal, a message that requests issuing at least one of an IDentification (ID) and the access level, and to transmit to the terminal, a response message that assigns at least one of the ID and the access level.

15. The server of claim 14, wherein the access level information is included in a Type Name Format (TNF) field of the header.

16. The server of claim 15, wherein the access level information is included in an External type field of the TNF field.
